(19) United States
(12) Patent Application Publication
(10) Pub. No.: US 2009/0309550 A1
(43) Pub. Date: Dec. 17, 2009

(54) Auto-rechargeable wireless computer peripheral

(75) Inventor: Chih-Min Liu, Taipei County (TW)

Correspondence Address: BACON & THOMAS, PLLC, 625 SLATERS LANE, FOURTH FLOOR, ALEXANDRIA, VA, 22314-1176, US

(73) Assignee: KYE SYSTEMS CORP., Taipei County (TW)

(21) Appl. No.: 12/222,674

(22) Filed: Aug. 14, 2008

(30) Foreign Application Priority Data
Jun. 13, 2008 (TW) 097122267

(51) Int. Cl. H02J 7/00

(52) U.S. Cl. 320/137

(57) ABSTRACT

An auto-rechargeable wireless computer peripheral includes a wireless power supply module and a wireless receiving module. The wireless power supply module is used for transmitting an electromagnetic wave. The wireless receiving module is corresponding to the wireless power supply module, for receiving the electromagnetic wave, converting the electromagnetic wave into an electric power, and storing the electric power. When the electric power stored by the wireless receiving module is lower than a rated value, the wireless receiving module outputs a charging signal, and the wireless power supply module receives the charging signal and transmits the electromagnetic wave in response to the charging signal, so as to automatically charge the wireless receiving module.

### CROSS-REFERENCE TO RELATED APPLICATIONS

This non-provisional application claims priority under 35 U.S.C. §119(a) on Patent Application No(s). 097122267 filed in Taiwan, R.O.C. on Jun. 13, 2008, the entire contents of which are hereby incorporated by reference.

### BACKGROUND

1. Field of Invention

The present invention relates to a computer peripheral, and more particularly to an auto-rechargeable wireless computer peripheral.

2. Related Art

Currently, a wireless computer peripheral is usually installed with a battery or a rechargeable battery. Capable of being recharged, the rechargeable battery has gradually become one of the main electric power sources adopted by wireless devices. However, the wireless device installed with a rechargeable battery still has to be loaded on a charger, or the rechargeable battery has to be taken off for charging, so it is very inconvenient in use. Therefore, for the ease of use, a wireless power supply technique is gradually developed to achieve the purpose of charging without direct electrical contact.

The wireless power supply technique employs the electromagnetic induction principle. In detail, a current is input into a coil, the coil then generates a magnetic field, and the magnetic field again induces a current in another coil. Therefore, when an energy source transmitter transmits a current to an inductive antenna, the inductive antenna generates an electromagnetic field and transmits an electromagnetic wave. The electromagnetic wave is transmitted through the air to an internal inductive antenna of a wireless device, so as to generate an induced current.

However, when the electric power of a wireless computer peripheral is insufficient, the corresponding wireless power supplier can neither automatically know the electric power state of the wireless electronic device, nor automatically charge the wireless electronic device. Therefore, the device still has to be charged by the user manually, and it is inconvenient in use, so a solution is needed.

### SUMMARY OF THE INVENTION

Accordingly, the present invention is directed to an auto-rechargeable wireless computer peripheral, so as to solve the problem of inconvenience in use in the prior art that a wireless charging must usually be manually performed on a wireless computer peripheral.

An auto-rechargeable wireless computer peripheral including a wireless power supply module and a wireless receiving module is provided.

The wireless power supply module is used for transmitting an electromagnetic wave. The wireless receiving module is corresponding to the wireless power supply module, for receiving the electromagnetic wave, converting the electromagnetic wave into an electric power, and storing the electric power. When the electric power stored by the wireless receiving module is lower than a rated value, the wireless receiving module outputs a charging signal, and the wireless power supply module receives the charging signal and transmits the electromagnetic wave in response to the charging signal.

A power receiving circuit is corresponding to the wireless power supply module, for receiving the electromagnetic wave, converting the electromagnetic wave into the electric power, and storing the electric power. A voltage detecting circuit is electrically connected to the power receiving circuit, for detecting the stored electric power. A micro-processing unit is electrically connected to the voltage detecting circuit, for generating the charging signal. A transmitting antenna is electrically connected to the micro-processing unit, for transmitting the charging signal. When the electric power stored by the wireless receiving module is lower than the rated value, the micro-processing unit generates the charging signal.

A power transmitting circuit is corresponding to the wireless receiving module, for transmitting the electromagnetic wave.

A micro-processing unit is electrically connected to the power transmitting circuit, for controlling the power transmitting circuit to transmit the electromagnetic wave. A receiving antenna is electrically connected to the micro-processing unit, for receiving and transmitting the charging signal to the micro-processing unit. When the wireless power supply module receives the charging signal, the micro-processing unit controls the power transmitting circuit to transmit the electromagnetic wave.

### BRIEF DESCRIPTION OF THE DRAWINGS

The present invention will become more fully understood from the detailed description given herein below for illustration only, and thus are not limitative of the present invention, and wherein:

FIG. 1 is a block diagram of an auto-rechargeable wireless computer peripheral of the present invention;

FIG. 2 is a circuit diagram of a power receiving circuit of a wireless receiving module according to the present invention;

FIG. 3 is a circuit diagram of a power transmitting circuit of a wireless power supply module according to the present invention;

FIG. 4A is a schematic view of an auto-rechargeable wireless computer peripheral according to a first embodiment of the present invention;

FIG. 4B is a schematic view of an auto-rechargeable wireless computer peripheral according to a second embodiment of the present invention; and

FIG. 4C is a schematic view of an auto-rechargeable wireless computer peripheral according to a third embodiment of the present invention.

### DETAILED DESCRIPTION OF THE INVENTION

The detailed features and advantages of the present invention will be described in detail in the following embodiments. Those skilled in the arts can easily understand and implement the content of the present invention. Furthermore, the relative objectives and advantages of the present invention are apparent to those skilled in the arts with reference to the content disclosed in the specification, claims, and drawings. The embodiments below are only used to illustrate the principle of the present invention, instead of limiting the scope of the same.

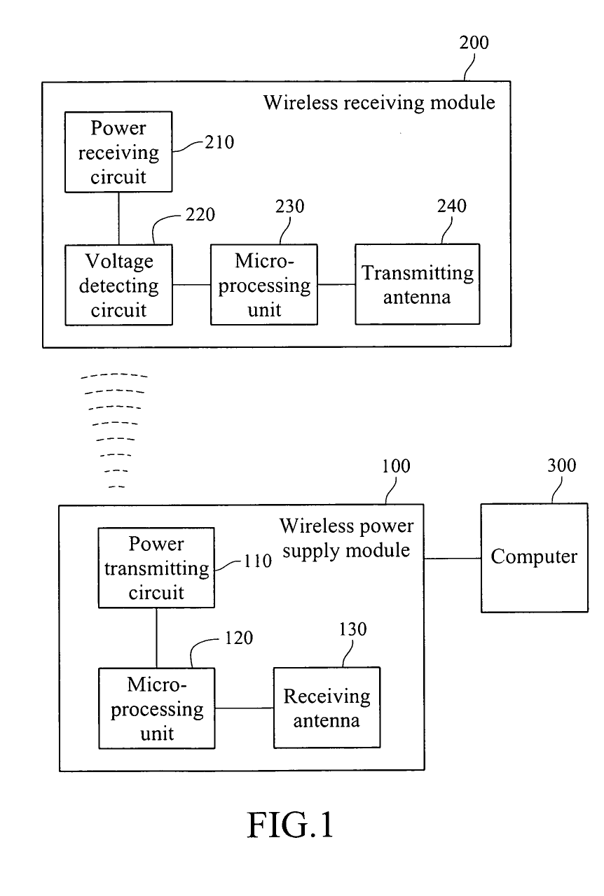

The wireless computer peripheral of the present invention includes, but not limited to, a mouse, a keyboard, or a game controller. The computer of the present invention includes, but not limited to, a desktop computer, a notebook computer, or a portable computer device. Referring to FIG. 1, a block diagram of an auto-rechargeable wireless computer peripheral according to an embodiment of the present invention is shown.

As shown in FIG. 1, an auto-rechargeable wireless computer peripheral includes a wireless power supply module 100 and a wireless receiving module 200.

The wireless power supply module 100 transmits an electromagnetic wave to the wireless receiving module 200. The wireless receiving module 200 receives the electromagnetic wave, converts the electromagnetic wave into an electric power, and stores the electric power.

When the electric power stored by the wireless receiving module 200 is lower than a rated value, the wireless receiving module 200 outputs a charging signal. On receiving the charging signal, the wireless power supply module 100 transmits the electromagnetic wave to the wireless receiving module 200 in response to the charging signal, so as to automatically charge the wireless receiving module 200.

Here, the wireless power supply module 100 and the wireless receiving module 200 interact through a mutually corresponding wireless radio frequency (RF) signal frequency. For example, it is preset that a signal is transmitted by a wireless RF signal frequency of 13.56 MHz, and the frequency may be changed according to different designs and requirements. However, the above description is only for exemplification, instead of limiting the implementation aspect of the present invention.

The wireless receiving module 200 includes a power receiving circuit 210, a voltage detecting circuit 220, a micro-processing unit 230, and a transmitting antenna 240.

The voltage detecting circuit 220 is electrically connected to the power receiving circuit 210. The micro-processing unit 230 of the wireless receiving module 200 is electrically connected to the voltage detecting circuit 220. The transmitting antenna 240 of the wireless receiving module 200 is electrically connected to the micro-processing unit 230 of the wireless receiving module 200.

The power receiving circuit 210 is corresponding to the wireless power supply module 100. The power receiving circuit 210 receives the electromagnetic wave transmitted from the wireless power supply module 100, converts the electromagnetic wave into the electric power, and stores the electric power. The voltage detecting circuit 220 detects the electric power stored by the power receiving circuit 210. The micro-processing unit 230 of the wireless receiving module 200 generates the charging signal. The transmitting antenna 240 of the wireless receiving module 200 transmits the charging signal.

When the electric power stored by the wireless receiving module 200 is lower than a rated value, the micro-processing unit 230 of the wireless receiving module 200 generates the charging signal, and the transmitting antenna 240 of the wireless receiving module 200 transmits the charging signal to the wireless power supply module 100, such that the wireless power supply module 100 automatically charges the wireless receiving module 200.

Here, the rated value represents a preset comparison reference of a potential of the wireless receiving module 200. For example, if the electric power stored by the wireless receiving module 200 is higher than the rated value, it means that the electric power of the wireless receiving module 200 is still sufficient for use and a charging is not required. If the electric power stored by the wireless receiving module 200 is lower than the rated value, it means that the electric power of the wireless receiving module 200 is insufficient and a charging is required. The rated value may be changed according to different designs and specifications. However, the above description is only for exemplification, instead of limiting the implementation aspect of the present invention.

The wireless power supply module 100 includes a power transmitting circuit 110, a micro-processing unit 120, and a receiving antenna 130.

The micro-processing unit 120 of the wireless power supply module 100 is electrically connected to the power transmitting circuit 110. The receiving antenna 130 of the wireless power supply module 100 is electrically connected to the micro-processing unit 120 of the wireless power supply module 100.

The power transmitting circuit 110 is corresponding to the wireless receiving module 200. The power transmitting circuit 110 transmits the electromagnetic wave to the wireless receiving module 200. The micro-processing unit 120 of the wireless power supply module 100 controls the power transmitting circuit 110 to transmit the electromagnetic wave. The receiving antenna 130 of the wireless power supply module 100 receives the charging signal of the wireless receiving module 200, and transmits the charging signal to the micro-processing unit 120 of the wireless power supply module 100.

When the wireless power supply module 100 receives the charging signal of the wireless receiving module 200, the micro-processing unit 120 of the wireless power supply module 100 controls the power transmitting circuit 110 to transmit the electromagnetic wave to the wireless receiving module 200, so as to automatically charge the wireless receiving module 200.

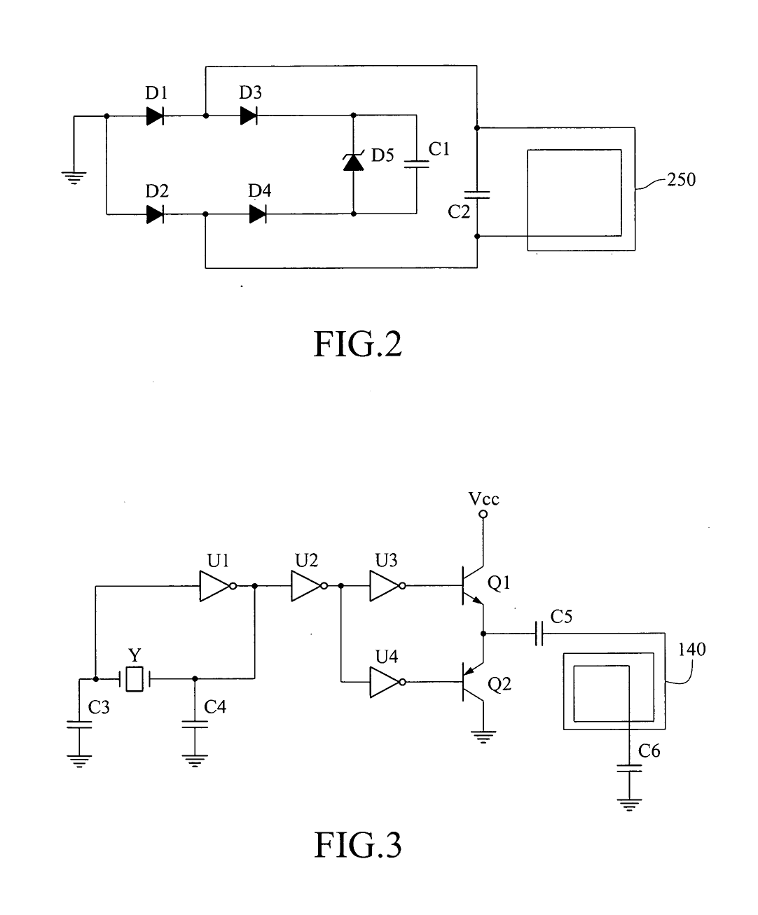

Referring to FIG. 2, a circuit diagram of the power receiving circuit 210 of the wireless receiving module 200 according to an embodiment of the present invention is shown. In FIG. 2, the power receiving circuit 210 includes a first diode D1, a second diode D2, a third diode D3, a fourth diode D4, a fifth diode D5, a first capacitor C1, a second capacitor C2, and a receiving antenna 250.

An anode of the first diode D1 is grounded. An anode of the second diode D2 is electrically connected to the anode of the first diode D1. An anode of the third diode D3 is electrically connected to a cathode of the first diode D1. An anode of the fourth diode D4 is electrically connected to a cathode of the second diode D2. An anode of the fifth diode D5 is electrically connected to a cathode of the fourth diode D4, and a cathode of the fifth diode D5 is electrically connected to a cathode of the third diode D3 and the voltage detecting circuit 220. The first capacitor C1 and the fifth diode D5 are connected in parallel. A first end of the second capacitor C2 is electrically connected to the anode of the third diode D3, and a second end of the second capacitor C2 is electrically connected to the anode of the fourth diode D4. The receiving antenna 250 and the second capacitor C2 of the power receiving circuit 210 are connected in parallel.

Here, the second capacitor C2 matches the receiving antenna 250 of the power receiving circuit 210. The first capacitor C1 stores the electric power. The first diode D1, the second diode D2, the third diode D3, the fourth diode D4, and the fifth diode D5 are rectifying circuits for converting the electromagnetic wave received by the receiving antenna 250 of the power receiving circuit 210.

Further, the second capacitor C2 may be replaced by a rechargeable battery, and the fifth diode D5 may be a Zener diode capable of adjusting the voltage. However, those are for exemplification only.

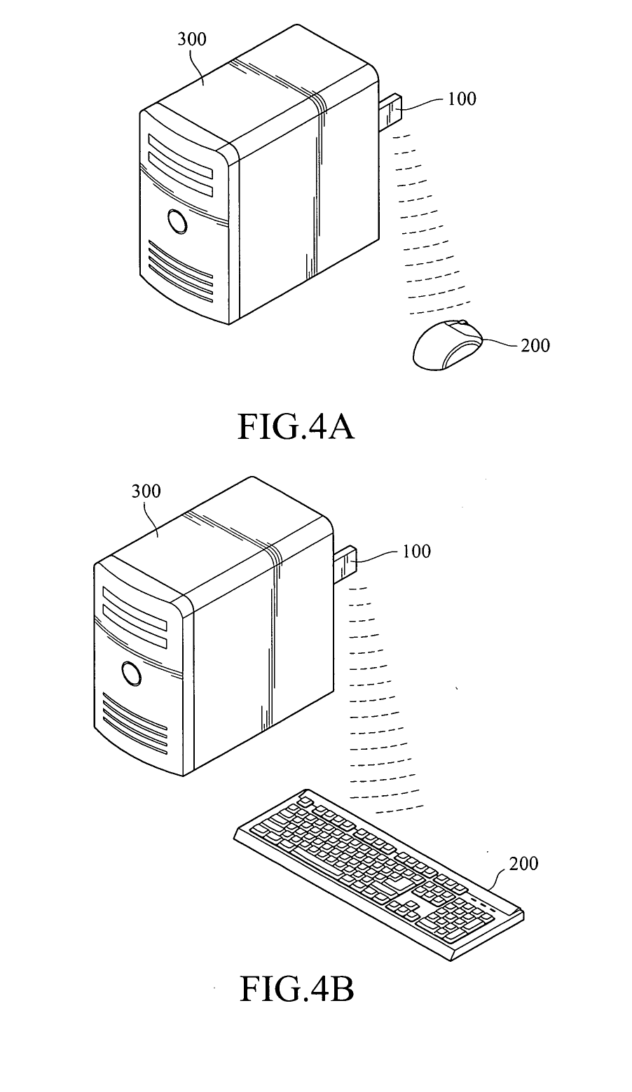

Referring to FIG. 3, a circuit diagram of the power transmitting circuit 110 according to an embodiment of the present invention is shown. In FIG. 3, the power transmitting circuit 110 includes a first capacitor C3, an oscillator Y, a second capacitor C4, a first inverter U1, a second inverter U2, a third inverter U3, a fourth inverter U4, a first transistor Q 1, a second transistor Q2, a third capacitor C5, a transmitting antenna 140, and a fourth capacitor C6.

A first end of the first capacitor C3 is grounded. A first end of the oscillator Y is electrically connected to a second end of the first capacitor C3. A first end of the second capacitor C4 is electrically connected to a second end of the oscillator Y, and a second end of the second capacitor C4 is grounded. An input end of the first inverter U1 is electrically connected to the first end of the oscillator Y, and an output end of the first inverter U1 is electrically connected to the second end of the oscillator Y An input end of the second inverter U2 is electrically connected to the output end of the first inverter U1. An input end of the third inverter U3 is electrically connected to an output end of the second inverter U2. An input end of the fourth inverter U4 is electrically connected to the output end of the second inverter U2. A base of the first transistor Q1 is electrically connected to an output end of the third inverter U3, and a collector of the first transistor Q1 is connected to a voltage source VCC. A base of the second transistor Q2 is electrically connected to an output end of the fourth inverter U4, an emitter of the second transistor Q2 is electrically connected to an emitter of the first transistor Q1, and a collector of the second transistor Q2 is grounded. A first end of the third capacitor C5 is electrically connected to the emitter of the first transistor Q1. A first end of the transmitting antenna 140 of the power transmitting circuit 110 is electrically connected to a second end of the third capacitor C5. A first end of the fourth capacitor C6 is electrically connected to a second end of the transmitting antenna 140 of the power transmitting circuit 110, and a second end of the fourth capacitor C6 is grounded.

Here, the first capacitor C3, the oscillator Y, the second capacitor C4, the first inverter U1, the second inverter U2, the third inverter U3, and the fourth inverter U4 control the first transistor Q1 and the second transistor Q2 to output a current, such that the transmitting antenna 140 of the power transmitting circuit 110 transmits an electromagnetic wave. The third capacitor C5 and the fourth capacitor C6 match the transmitting antenna 140 of the power transmitting circuit 110.

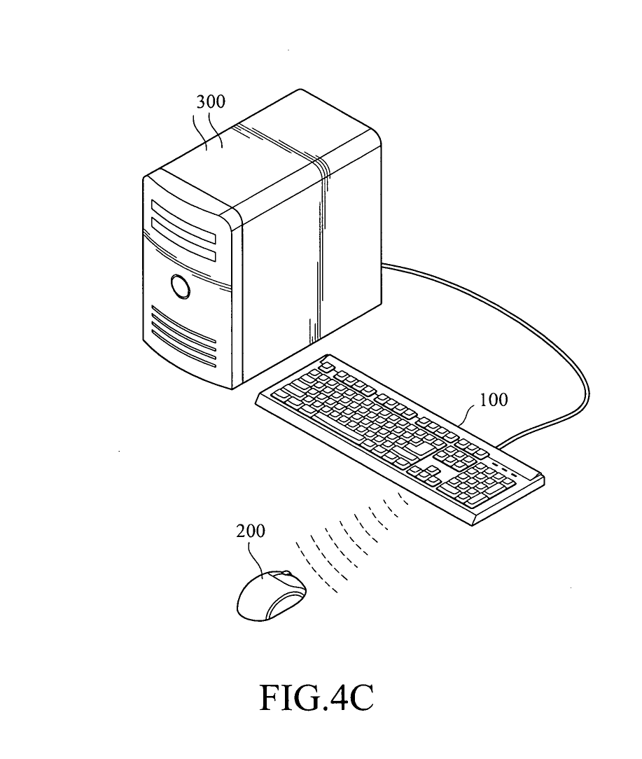

Referring to FIG. 4A, a schematic view of an auto-rechargeable wireless computer peripheral according to a first embodiment of the present invention is shown. In FIG. 4A, the wireless power supply module 100 is built in a wireless signal receiver and connected to a computer 300. The wireless receiving module 200 is built in a wireless computer input device, for example, a wireless mouse. Therefore, the wireless mouse may control the operation of the computer 300 through the wireless signal receiver. The wireless power supply module 100 transmits an electromagnetic wave to the wireless receiving module 200, and the power receiving circuit 210 receives and converts the electromagnetic wave into an electric power for power supply.

Referring to FIG. 4B, a schematic view of an auto-rechargeable wireless computer peripheral according to a second embodiment of the present invention is shown. In FIG. 4B, the wireless power supply module 100 is built in a wireless signal receiver and connected to a computer 300. The wireless receiving module 200 is built in a wireless computer input device, for example, a wireless keyboard. The operating process and principle of this embodiment are identical to those of the first embodiment.

Referring to FIG. 4C, a schematic view of an auto-rechargeable wireless computer peripheral according to a third embodiment of the present invention is shown. In FIG. 4C, the wireless power supply module 100 and the wireless signal receiver may be both built in a computer peripheral externally connected to a computer 300, for example, a wireless keyboard. Meanwhile, the wireless receiving module 200 is built in a wireless mouse. The operating process and principle of this embodiment are identical to those of the first embodiment.

In view of the above, when detecting that the electric power stored by the wireless receiving module is lower than a rated value, the auto-rechargeable wireless computer peripheral of the present invention outputs a charging signal to the wireless power supply module, such that the wireless power supply module transmits an electromagnetic wave to the wireless receiving module in response to the charging signal, so as to automatically charge the wireless receiving module.

What is claimed is:

1. An auto-rechargeable wireless computer peripheral, comprising:
a wireless power supply module, for transmitting an electromagnetic wave; and
a wireless receiving module, connected to a computer, and corresponding to the wireless power supply module, for receiving the electromagnetic wave, converting the electromagnetic wave into an electric power, and storing the electric power,
wherein when the electric power stored by the wireless receiving module is lower than a rated value, the wireless receiving module outputs a charging signal, and the wireless power supply module receives the charging signal and transmits the electromagnetic wave in response to the charging signal.

2. The auto-rechargeable wireless computer peripheral according to claim 1, wherein the wireless receiving module comprises:
a power receiving circuit, corresponding to the wireless power supply module, for receiving the electromagnetic wave, converting the electromagnetic wave into the electric power, and storing the electric power;
a voltage detecting circuit, electrically connected to the power receiving circuit, for detecting the stored electric power;
a micro-processing unit, electrically connected to the voltage detecting circuit, for generating the charging signal; and
a transmitting antenna, electrically connected to the micro-processing unit, for transmitting the charging signal,
wherein when the electric power stored by the wireless receiving module is lower than the rated value, the micro-processing unit generates the charging signal.

3. The auto-rechargeable wireless computer peripheral according to claim 1, wherein the wireless power supply module comprises:
a power transmitting circuit, corresponding to the wireless receiving module, for transmitting the electromagnetic wave;
a micro-processing unit, electrically connected to the power transmitting circuit, for controlling the power transmitting circuit to transmit the electromagnetic wave; and
a receiving antenna, electrically connected to the micro-processing unit, for receiving and transmitting the charging signal to the micro-processing unit,
wherein when the wireless power supply module receives the charging signal, the micro-processing unit controls the power transmitting circuit to transmit the electromagnetic wave.

4. The auto-rechargeable wireless computer peripheral according to claim 1, wherein the wireless receiving module is built in a wireless computer input device, and the wireless power supply module is built in a wireless signal receiver.

5. The auto-rechargeable wireless computer peripheral according to claim 4, wherein the wireless signal receiver is built in a computer peripheral externally connected to the computer.

6. An auto-rechargeable computer peripheral, comprising:
a wireless receiving module, at least having a power receiving circuit and a transmitting antenna, for transmitting a charging signal; and
a wireless power supply module, at least having a power transmitting circuit for generating an electromagnetic wave and a receiving antenna, for receiving the charging signal,
wherein the wireless power supply module is connected to a computer, for receiving the charging signal, the power transmitting circuit transmits the electromagnetic wave, and the power receiving circuit receives and converts the electromagnetic wave into an electric power.

7. The computer peripheral according to claim 6, wherein the wireless receiving module is built in a wireless computer input device, and the wireless power supply module is built in a wireless signal receiver.

8. The computer peripheral according to claim 7, wherein the wireless signal receiver is built in an externally connected computer peripheral.
